(19) United States
(12) Patent Application Publication
(10) Pub. No.: US 2007/0007322 A1
(43) Pub. Date: Jan. 11, 2007

(54) Board assembly apparatus having electronic components disposed in a space between circuit boards and a manufacturing method thereof

(76) Inventors: Jong-sung Lee, Seoul (KR); Yoon-sung Kim, Yongin-si (KR); Young-jun Moon, Suwon-si (KR); Se-young Jang, Seongnam-si (KR)

Correspondence Address: STANZIONE & KIM, LLP, 919 18TH STREET, N.W., SUITE 440, WASHINGTON, DC, 20006, US

(21) Appl. No.: 11/325,308

(22) Filed: Jan. 5, 2006

(30) Foreign Application Priority Data
Jul. 6, 2005 (KR) 2005-60608

(51) Int. Cl. B23K 31/02; B23K 31/00

(52) U.S. Cl. 228/180.22

(57) ABSTRACT

A board assembly apparatus and a manufacturing method includes applying solder paste onto a first surface of a first board, arranging electronic components on the first surface of the first board on which the solder paste is applied, arranging a second board above the electronic components and the first surface of the first board, and curing the solder paste.

### CROSS-REFERENCE TO RELATED APPLICATIONS

This application claims priority from Korean Patent Application No. 2005-0060608, filed on Jul. 6, 2005, in the Korean Intellectual Property Office, the entire disclosure of which is incorporated herein by reference.

### BACKGROUND OF THE INVENTION

1. Field of the Invention

The present general inventive concept relates to a board assembly apparatus having electronic components disposed between circuit boards and a manufacturing method thereof, and more particularly, to a board assembly apparatus having electronic components disposed between circuit boards and a manufacturing method which can manufacture a highly-integrated board assembly by mounting electronic components in a space between boards.

2. Description of the Related Art

Printed circuit boards (PCB) are widely used components of electronic products ranging from home electric appliances, such as digital televisions and computers, to high-technology communication apparatuses. These boards allow electronic components, such as integrated circuits, resistors and switches, or signal lines to be electrically connected to each other or allow signals to be transmitted by forming signal lines on a main body of the board.

Various electronic components are mounted on the surface of each of the boards such that the electronic components are electrically connected to each of the boards. As the electronic components are made multi-functional and lightweight, high-density mounting is required for many electronic components on a narrow board. A ball grid array is one method that uses solder balls to mount a package on a board for the purpose of improving electrical characteristics through minimization of electrical signal paths.

As illustrated in FIG. 1, a conventional board assembly 10 comprises a main board body 1, a passive element 7 and a flip chip 5 mounted on the main board body 1, an auxiliary board 3 formed by a ball grid array method, and holes 9 electrically connecting the auxiliary board 3 with the flip chip 5. With this configuration, the main board body 1, the auxiliary board 3, the passive element 7 and the flip chip 5 are electrically connected with each other to perform predetermined operations.

In this conventional board assembly of FIG. 1, in which an auxiliary board 3 formed by the ball grid array method is mounted on the main board body 1, there is a problem in that the space between a lower surface of the auxiliary board 3 and the main board body 1 is not utilized at the time of design. Thus, in the conventional board assembly, there is a possibility that a lack of compactness together with multi-functionality of electronic components may cause electrical interference because a high density of the electronic components mounted on a common board may cause noises or the like to occur because a length of electrical connecting lines is increased.

### SUMMARY OF THE INVENTION

The present general inventive concept provides a board assembly apparatus having electronic components disposed in a space between circuit boards by mounting electronic components in a space between boards, and a manufacturing method thereof.

Additional aspects of the present general inventive concept will be set forth in part in the description which follows and, in part, will be obvious from the description, or may be learned by practice of the general inventive concept.

The foregoing and/or other aspects of the present general inventive concept can be achieved by providing a board assembly manufacturing method comprising applying solder paste onto a first surface of a first board, arranging electronic components on the first surface of the first board on which the solder paste is applied, arranging a second board above the electronic components and the first surface of the first board, and curing the solder paste.

The second board may be arranged by at least one of a ball grid array method and a column grid array method.

The board assembly manufacturing method may further comprise reversing the first board so that the first surface of the first board faces downward, applying the solder paste onto a second surface of the first board, arranging electronic components on the second surface of the first board on which the solder paste is applied, arranging a third board above the electronic components and the second surface of the first board, and curing the solder paste.

The board assembly manufacturing method may further comprise applying the solder paste onto an upper surface of the second board, arranging electronic components on the upper surface of the second board on which the solder paste is applied, and curing the solder paste.

The board assembly manufacturing method may further comprise arranging a third board above the electronic components and the upper surface of the second board, and curing the solder paste.

The electronic components may include at least one of a flip chip, an angular chip, a wafer-level chip size package and a passive element.

The foregoing and/or other aspects of the present general inventive concept can also be achieved by providing a board assembly manufacturing method comprising applying solder paste onto a first part of an upper surface of a first board, seating a film on a second part of the upper surface of the first board, arranging electronic components on the upper surface of the first board on which the solder paste is applied, arranging electronic components on the upper surface of the first board on which the film is seated, bonding the first board to the electronic components seated on the film, arranging a second board above the electronic components and the upper surface of the first board, and curing the solder paste.

The electronic components arranged on the upper surface of the board having the film seated thereon include flip chips, and the film is either an anisotropic conductive film (ACF) or a nonconductive film (NCF).

It is to be understood that both the foregoing general description and the following detailed description are exemplary and explanatory and are intended to provide further explanation of the general inventive concept as claimed.

The foregoing and/or other aspects of the present general inventive concept can also be achieved by providing a board assembly manufacturing method comprising applying at least one of a solder paste and a film onto a first surface of a first board, arranging electronic components on the first surface of the first board on which the at least one of the solder paste and the film is applied, arranging a second board on top of the electronic components and the first surface of the first board such that one or more supports which separate the second board from the first board form a space in which the electronic components are disposed, and curing the solder paste.

The foregoing and/or other aspects of the present general inventive concept can also be achieved by providing a board assembly apparatus comprising a first board having at least one of solder paste and film applied onto a first surface of the first board, a plurality of electronic components disposed on the at least one of the solder paste and the film disposed on the first surface of the first board, a second board disposed on top of the electronic components and the first surface of the first board such that one or more supports which separate the second board from the first board form a space in which the electronic components are disposed.

The foregoing and/or other aspects of the present general inventive concept can also be achieved by providing a board assembly apparatus comprising a first board having solder paste disposed on a surface of the first board, electronic components arranged on the surface of the first board on which the solder paste is applied, and a second board arranged above the electronic components and the surface of the first board.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a sectional view of a conventional board assembly;

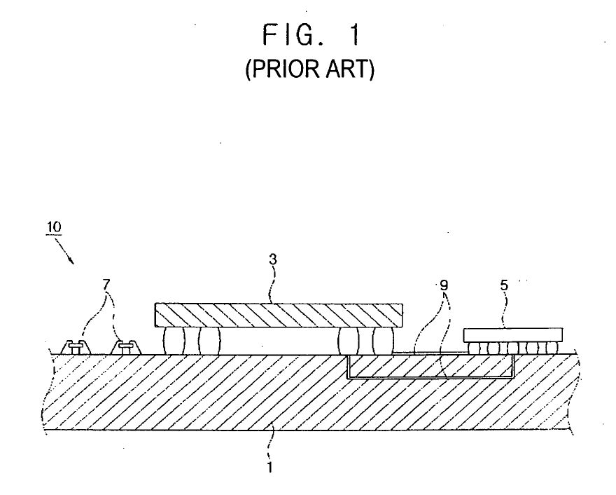

FIG. 2 is a schematic diagram illustrating an embodiment of a board assembly according to the present general inventive concept;

FIG. 3 is a schematic diagram illustrating an embodiment of a board assembly according to the present general inventive concept;

FIG. 4 is a schematic diagram illustrating an embodiment of a board assembly according to the present general inventive concept; and

FIG. 5 is a schematic diagram illustrating an embodiment of a board assembly according to the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

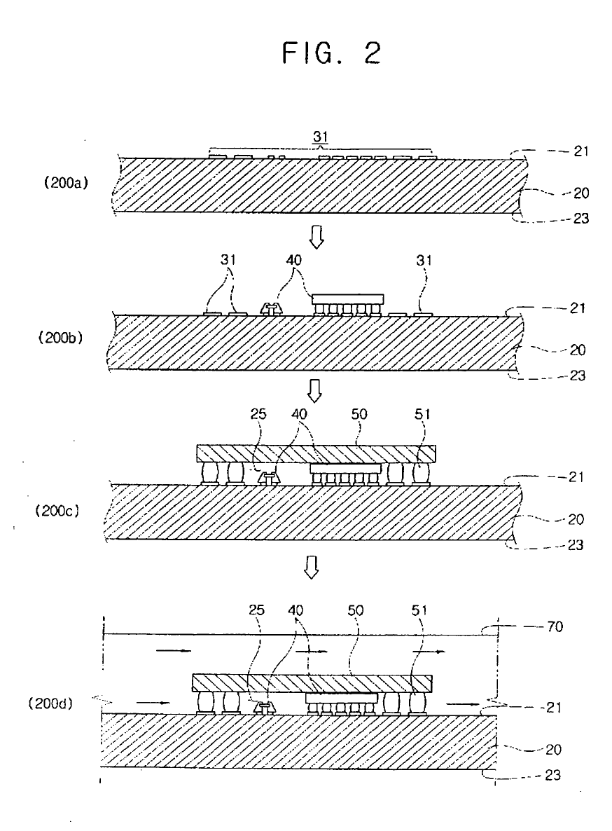

As illustrated in FIG. 2, a board assembly manufacturing method according to an embodiment of the present general inventive concept comprises a paste applying operation 200a of applying solder paste 31 onto an upper surface 21 of a first board 20, a component arranging operation 200b of arranging electronic components 40 on the upper surface 21 of the first board 20 on which the solder paste 31 is applied, a second board arranging operation 200c of arranging a second board 50 above the electronic components 40 and the upper surface 21 of the first board 20, and a paste curing operation 200d of curing the solder paste 31.

In the paste applying operation 200a, the solder paste 31 is applied on the first board 20 to allow the second board 50 and the electronic components 40 to be mounted on the first board 20. In the paste applying operation 200a, the solder paste 31 may be applied at predetermined positions on the upper surface 21 of the first board 20, using, for example, such an apparatus as a screen printer.

The first board 20 is typically employed as a main board, and may include known kinds of thin film boards made of, for example, an epoxy film, a polyimide film, a polyester film, a polyetherimide film, or the like.

The solder paste 31 may selectively employ alloys which contain tin (Sn) as their main component and a conductive material such as copper, silver, or the like.

In the component arranging operation 200b, the electronic components 40 are arranged on the upper surface 21 of the first board 20 on which the solder paste 31 is applied. In the operation 200b, an apparatus such as a known chip mounting apparatus (not shown) may be used, which automatically arranges electronic components at the spots on which the solder paste 31 are applied.

The electronic component 40 may include a flip chip, a polygonal chip, a water-level chip size package (W-CSP), and a passive element. The flip chip, for example, is mounted by electrically connecting a die and electrodes in which wiring is formed using conductive bumps on the surface of the die. The W-CSP is made cubic by processing a wafer to the final process of semiconductor assembling. The passive element which may be used as one of the electronic components 40 includes a resistor, a coil, a capacitor, a switch, or the like, and exhibits its intended operations when combined with an active element. The electronic components 40 are mounted on the upper surface 21 of the first board 20, and are electrically connected to the first board 20.

In the second board arranging operation 200c, the second board 50 is arranged at predetermined positions above the electronic components 40 and the upper surface 21 of the first board 20. To this end, an apparatus such as a known chip mounting apparatus (not shown) may be used to automatically arrange the electronic components 40 at the positions on which the solder paste 31 is applied.

An accommodating portion 25 is formed between the first and second respective boards 20 and 50, in which the electronic components 40 are mounted. Accordingly, the electronic components 40 are mounted on the accommodating portions 25, so that high density and multi-functionality of the electronic components 40 can be achieved and a length of signal lines can be reduced.

The second board 50 may be formed by the ball grid array method. Another method, such as a column grid array method capable of forming the accommodating portions 25, may also be used to form the second board 50. Using the ball grid array method to form the second board 50, the accommodating portions 25 are formed by the space created by the solder balls 51 between the upper surface 21 of the first board 20 and a lower surface of the second board 50. Alternatively, using the column grid array method to form the second board 50, the accommodating portions 25 are formed by pins (not shown) between the surface of the first board 20 and the surface of the second board 50.

In the paste curing operation 200d of FIG. 2, the solder paste 31 is cured after being melted onto the upper surface 21 of the first board 20. Accordingly, the electronic components 40 and the second board 50 can be firmly joined to the first board 20 by the solder paste 31. In operation 200d, an apparatus such as a curing machine using a reflow method may be employed to cure the solder paste 31.

A board assembly manufacturing process according to an embodiment of the present general inventive concept will be described below with reference to FIG. 2.

The first board 20 may be located on a flat plate-shaped working table. In the paste applying operation 200a, the solder paste 31 is applied onto the upper surface 21 of the first board 20 to join the electronic components 40 and the second board 50 to the first board 20. Thereafter, in the component arranging operation 200b, the electronic components 40 are arranged on the upper surface 21 of the first board 20 on which the solder paste 31 is applied such that the electronic components 40 are disposed in an area underneath where the second board 50 will be located. In the second board arranging operation 200c, the second board 50 is arranged above the electronic components 40 and the upper surface 21 of the first board 20 so that the electronic components 40 can be mounted on the accommodating portions 25 formed between the upper surface 21 of the first board 20 and the lower surface of the second board 50. Thereafter, in the paste curing operation 200d, the solder paste 31 is cured. Accordingly, the electronic components 40 and the second board 50 can be firmly joined to the first board 20.

As a result, since the electronic components 40 can be mounted using the space above the upper surface 21 of the first board 20 and below the second board 50, high density and the multi-functionality of the electronic components 40 can be achieved. Also, the length of signal lines can be reduced, thereby reducing the amount of noises generated.

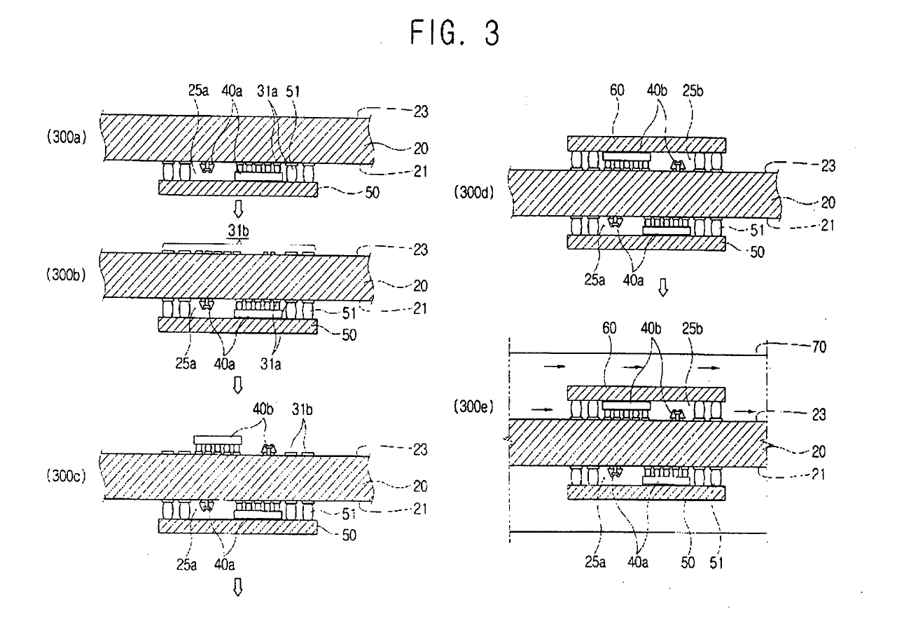

As illustrated in FIG. 3, a board assembly manufacturing method according to another embodiment of the present general inventive concept comprises a reversing operation 300a of reversing a position of the first board 20 so that its first surface 21 faces downward, a paste applying operation 300b of applying solder paste 31b onto a second surface 23 of the first board 20, a component arranging operation 300c of arranging electronic components 40b on the second surface 23 of the first board 20 on which the solder paste 31b is applied, a third board arranging operation 300d of arranging a third board 60 above the electronic components 40b and the second surface 23 of the first board 20, and a paste curing operation 300e of curing the solder paste 31b.

As a result, since the electronic components 40b can be mounted within an accommodating portion 25b above the second surface 23 of the first board 20 and below the lower surface of the third board 60, high density and multi-functionality of the electronic components 40b can be achieved. Also, the length of signal lines can be reduced, thereby reducing generation of noises.

Since the board assembly manufacturing method illustrated in FIG. 3 is similar to FIG. 2 except for the reversing operation 300a, any further description thereof will be omitted. It is noted in the reversing operation 300a that it is possible to employ a rotating apparatus (not shown) which can support an edge of the first board 20 and rotate the supported edge to reverse and return the orientation of the first board 20 so that the first surface 21 of the first board 20 faces downward and upward in accordance with the rotating apparatus.

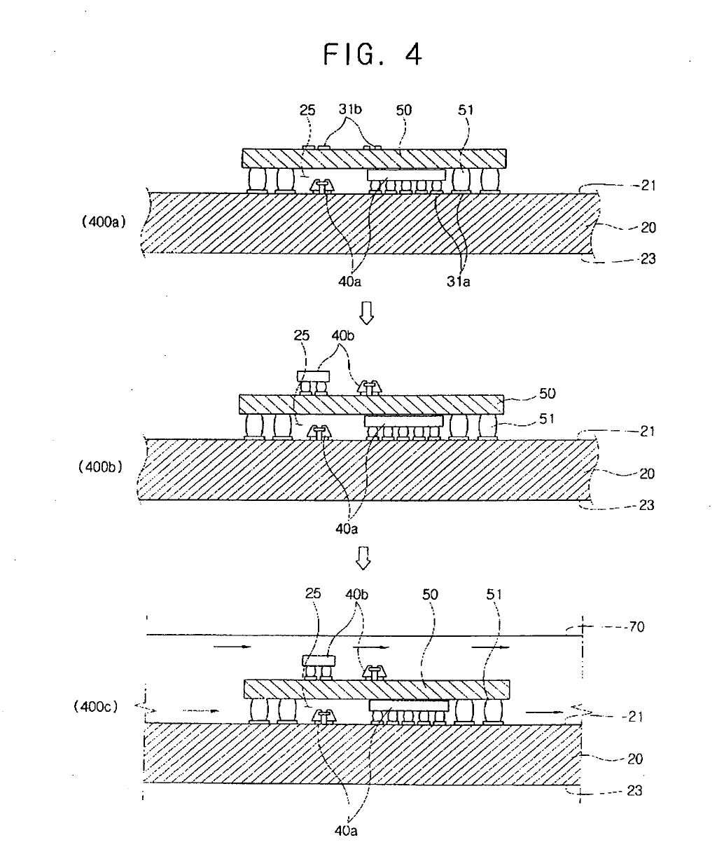

As illustrated in FIG. 4, a board assembly manufacturing method according to another embodiment of the present general inventive concept comprises a paste applying operation 400a of applying solder paste 31b onto an upper surface of the second board 50, an electronic component arranging operation 400b of arranging electronic components 40b on the upper surface of the second board 50 on which the solder paste 31b is applied, and a paste curing operation 400c of curing the solder paste 31b.

As a result, since the electronic components 40b can be mounted using the space above the upper surface of the second board 50, high density and multi-functionality of the electronic components 40b can be achieved. Also, the length of signal lines can be reduced, thereby reducing the amount of noises generated.

Since the board assembly manufacturing method according to FIG. 4 is similar to FIG. 2 except for mounting the electronic components 40b on the upper surface of the second board 50 as illustrated in FIG. 4, any further description thereof will be omitted. It is noted that the board assembly manufacturing method illustrated in FIG. 4 may further include the reversing operation 300a and other features included in FIG. 3.

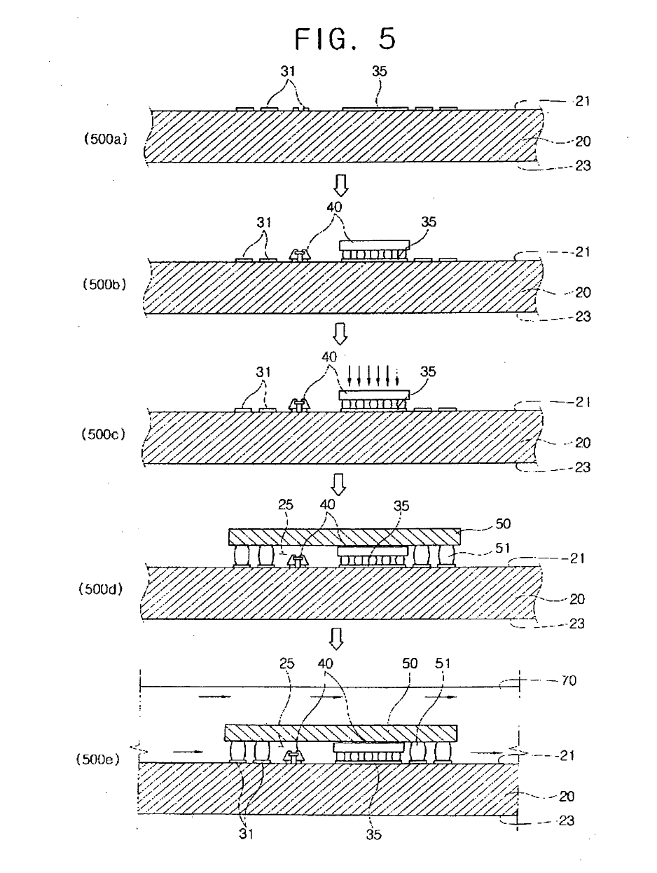

As illustrated in FIG. 5, a board assembly manufacturing method according to another embodiment of the present general inventive concept comprises a solder paste 31 being applied on a first portion of the upper surface 21 of the first board 20, a film seating operation 500a of seating a film 35 onto a second part of the upper surface 21 of the first board 20, a first component arranging operation (not shown) of arranging electronic components 40 on the first portion of the upper surface 21 of the first board 20 on which the solder paste 31 is applied, a second component arranging operation 500b of arranging electronic components 40 on the second portion of the upper surface 21 of the first board 20 on which the film 35 is seated, a bonding operation 500c of bonding the electronic components 40 seated on the film 35 to the first board 20, a second board arranging operation 500d of arranging a second board 50 above the electronic components 40 and the upper surface 21 of the first board 20, and a paste curing operation 500e of curing the solder paste 31.

Accordingly, the electronic components 40, such as flip chips, are mounted on the accommodating portions 25 between the upper surface 21 of the first board 20 and the lower surface of the second board 50, thereby achieving high density and multi-functionality of the electronic components 40. Any further description of the same operations as those in the other embodiments will be omitted.

In the film seating operation 500a, it is possible to use an apparatus which can automatically seat the film 35, and a chip mounting device (not shown) which automatically arranges the electronic components 40 once the film has been seated.

The electronic components 40 may include flip chips which can be joined to the first board 20 by the film 35.

The film 35 may be a thin anisotropic conductive film (ACF) and a nonconductive film (NCF).

In the bonding operation 500c, the film 35 is heated and pressed so that the electronic components 40 mounted on the seated film 35 can be joined to the first board 20. However, it is possible to selectively employ a method of performing the bonding after fluxes are applied onto the upper surface 21 of the first board 20, a method of joining metals to each other by using ultrasonic waves, or the like.

The board assembly apparatus illustrated in FIG. 5 may further include one or more of the above-mentioned operations described in FIGS. 3 and 4. The resulting configuration is similar to the above-mentioned ones, and thus any further description thereof will be omitted.

According to the present embodiment, electronic components are interposed between the first board 21 and the second board 50 and mounted on the upper surface 21 of the first board, so that high density electronic components can be achieved, thereby providing electronic products which are made compact and multi-functional. Also, the length of signal lines can be reduced, thereby reducing generation of noises.

As described above, according to the present general inventive concept, there is provided a board assembly manufacturing method which can manufacture a highly-integrated board assembly by mounting electronic components in a space between boards.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A board assembly manufacturing method comprising:
applying solder paste onto a first surface of a first board;
arranging electronic components on the first surface of the first board on which the solder paste is applied;
arranging a second board above the electronic components and the first surface of the first board; and
curing the solder paste.

2. The board assembly manufacturing method according to claim 1,
wherein the second board is arranged by at least one of a ball grid array method and a column grid array method.

3. The board assembly manufacturing method according to claim 1, further comprising:
reversing the first board so that the first surface of the first board faces downward;
applying the solder paste onto a second surface of the first board;
arranging electronic components on the second surface of the first board on which the solder paste is applied;
arranging a third board above the electronic components and the second surface of the first board; and
curing the solder paste.

4. The board assembly manufacturing method according to claim 1, further comprising:
applying the solder paste onto an upper surface of the second board;
arranging electronic components on the upper surface of the second board on which the solder paste is applied; and
curing the solder paste.

5. The board assembly manufacturing method according to claim 4, further comprising:
arranging a third board above the electronic components and the upper surface of the second board; and
curing the solder paste.

6. The board assembly manufacturing method according to claim 1, wherein the electronic components includes at least one of a flip chip, an angular chip, a wafer-level chip size package and a passive element.

7. The board assembly manufacturing method according to claim 2, wherein the electronic components includes at least one of a flip chip, an angular chip, a wafer-level chip size package and a passive element.

8. The board assembly manufacturing method according to claim 3, wherein the electronic components includes at least one of a flip chip, an angular chip, a wafer-level chip size package and a passive element.

9. The board assembly manufacturing method according to claim 4, wherein the electronic components includes at least one of a flip chip, an angular chip, a wafer-level chip size package and a passive element.

10. The board assembly manufacturing method according to claim 5, wherein the electronic components includes at least one of a flip chip, an angular chip, a wafer-level chip size package and a passive element.

11. A board assembly manufacturing method comprising:
applying solder paste onto a first part of an upper surface of a first board;
seating a film on a second part of the upper surface of the first board;
arranging electronic components on the upper surface of the first board on which the solder paste is applied;
arranging electronic components on the upper surface of the first board on which the film is seated;
bonding the first board to the electronic components seated on the film;
arranging a second board above the electronic components and the upper surface of the first board; and
curing the solder paste.

12. The board assembly manufacturing method according to claim 11, wherein the electronic components arranged on the upper surface of the board having the film seated thereon include flip chips, and the film is either an anisotropic conductive film (ACF) or a nonconductive film (NCF).

13. A board assembly manufacturing method comprising:
applying at least one of a solder paste and a film onto a first surface of a first board;
arranging electronic components on the first surface of the first board on which the at least one of the solder paste and the film is applied;
arranging a second board on top of the electronic components and the first surface of the first board such that one or more supports which separate the second board from the first board form a space in which the electronic components are disposed; and
curing the solder paste.

14. The board assembly manufacturing method according to claim 13, wherein the second board is substantially thinner than the first board.

15. The board assembly manufacturing method according to claim 13, wherein the supports are at least one of electrically conductive solder balls and pins.

16. A board assembly apparatus comprising:
a first board having at least one of solder paste and film applied onto a first surface of the first board;
a plurality of electronic components disposed on the at least one of the solder paste and the film disposed on the first surface of the first board;
a second board disposed on top of the electronic components and the first surface of the first board such that one or more supports which separate the second board from the first board form a space in which the electronic components are disposed.

17. The board assembly manufacturing method according to claim 16, wherein the second board is substantially thinner than the first board.

18. The board assembly manufacturing method according to claim 16, wherein the supports are at least one of solder and pins.

19. A board assembly apparatus comprising:
a first board having solder paste disposed on a surface of the first board;
electronic components arranged on the surface of the first board on which the solder paste is applied; and
a second board arranged above the electronic components and the surface of the first board.

20. The board assembly apparatus of claim 19, wherein the first board has first and second parts, the first part having solder paste disposed on a surface thereof and the second part having a film disposed on a surface thereof, and the electronic components are arranged on the first and second parts of the first board.
